(19) United States
(12) Patent Application Publication
(10) Pub. No.: US 2002/0103931 A1
(43) Pub. Date: Aug. 1, 2002

(54) Virtual private networking using domain name service proxy

(76) Inventor: Charles J. Mott, Idaho Falls, ID (US)

Correspondence Address: Eugene LeDonne, Esq., Reed Smith LLP, 375 Park Ave., 17th Floor, New York, NY, 10152, US

(21) Appl. No.: 09/770,932

(22) Filed: Jan. 26, 2001

(51) Int. Cl. G06F 15/16

(52) U.S. Cl. 709/245; 709/219

(57) ABSTRACT

A virtual private network using domain name service proxy, and a method of virtual private networking, are disclosed. The VPN using domain name service proxy includes a user computer in communicative connection with a VPN client, at least one switch within the VPN client, and a VPN gateway communicatively connected to the VPN client. The switch receives at least one domain name service inquiry directed to the first domain name server from the VPN client, and redirects the at least one domain name service inquiry away from the first domain name server to the second domain name server through the gateway. The gateway unencrypts the payload and sends the payload to the second domain name server, which returns to the gateway a resolution of the at least one domain name service inquiry. The method includes the steps of receiving a request from at least one user for at least one address that can be translated by a second DNS server, detecting that the at least one address cannot be translated by a first DNS server, wherein the first DNS server is then in use by the user, redirecting the request from the first DNS server to a gateway, wherein the gateway directs the request to the second DNS server, and wherein the second DNS server resolves the request and returns the address to the gateway, and receiving, from the gateway, the requested address formatted according to the first DNS server.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention is directed generally to a method and apparatus for domain name service and, more particularly, to virtual private networking using domain name service proxy.

2. Description of the Background

Large companies operating in the internet space generally have access for employees to the internet, as well as the company's intranet. The intranet typically includes information the company intends to maintain securely away from the public eye, but that same information is often necessary for employees to perform work tasks. Consequently, large companies typically give employees access to the intranet using an internal DNS server, and access to the internet using an external DNS server.

However, computers in a workplace, or those used by travelling employees, are often not configured, or are improperly configured, to enable those computers to use the correct server for intranet activities. Historically, the correct DNS server was hard-coded into a particular computer. Thus, if that computer lost the hard coding, or the hard code was incorrectly entered, or not entered, the particular computer would be unable to gain the necessary access, due to the fact that the DNS server or servers used could not translate the same addresses that the internal, i.e. intranet, DNS server could translate, and thus information from those addresses would be foreclosed from the user of that particular computer.

Certain solutions to this difficulty have involved making a series of operating calls to the operating system to force the operating system to use the correct DNS servers for desired tasks. However, this solution actually requires an overwriting in the operating system of certain information, such as the DNS server used by an ISP on that same particular computer. Such an overwriting could prevent use of the computer by the user for non-work related tasks without employer monitoring, and could unnecessarily place an additional drain on employer resources.

An alternative solution to the DNS problem would require systems personnel to access each unit that was improperly configured and re-configure the unit to use the correct DNS servers for the correct tasks. However, this solution can create a tremendous drain on technical personnel, and can prove very costly to an employer.

Therefore, a need exists for a system and method of providing DNS service for both private sites and public sites, without requiring technical personal to touch any non-configured or misconfigured desktop, and without requiring the overwriting of all DNS inquiries with the address of a particular DNS server.

### BRIEF SUMMARY OF THE INVENTION

The present invention is directed to a virtual private network using domain name service proxy that redirects a domain name service inquiry from a first domain name server that cannot resolve the inquiry to a second domain name service server that can resolve the inquiry. The VPN using domain name service proxy includes a user computer in communicative connection with a VPN client, at least one switch within the VPN client, and a VPN gateway communicatively connected to the VPN client. The switch receives at least one domain name service inquiry directed to the first domain name server from the VPN client. Upon activation of the switch, the switch redirects the at least one domain name service inquiry away from the first domain name server to the second domain name server through the gateway by sending at least one encrypted payload, including therein the at least one domain name service inquiry, to the gateway. The gateway then unencrypts the payload, modifies the packet header, and redirects to the second domain name server. The second domain name server returns to the gateway a resolution of the at least one domain name service inquiry, wherein the resolution includes therein information from a destination address for the at least one domain name service inquiry, and the gateway encrypts the information, modifies the packet header as though the resolution had come from the first domain name server, and returns the information to the VPN client.

The present invention also includes a method of virtual private networking. The method includes the steps of receiving a request from at least one user for at least one address that can be translated by a second DNS server, detecting that the at least one address cannot be translated by a first DNS server, wherein the first DNS server is then in use by the user, redirecting the request from the first DNS server to a gateway, wherein the gateway directs the request to the second DNS server, and wherein the second DNS server resolves the request and returns the address to the gateway, and receiving, from the gateway, the requested address formatted according to the first DNS server.

The present invention solves problems experienced with the prior art by providing a system and method for providing DNS service for both private sites and public sites, without requiring technical personal to touch any non-configured or misconfigured desktop, and without requiring the overwriting of all DNS inquiries with the address of a particular DNS server. Those and other advantages and benefits of the present invention will become apparent from the detailed description of the invention hereinbelow.

### BRIEF DESCRIPTION OF THE SEVERAL VIEWS OF THE DRAWING

For the present invention to be clearly understood and readily practiced, the present invention will be described in conjunction with the following figures, wherein:

FIG. 1 is a flow diagram illustrating a method of the virtual private networking; and

FIG. 2 is a block diagram illustrating the connection of the VPN client to the VPN gateway, and the connection of the VPn gateway to the correct DNS server.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical network system. Those of ordinary skill in the art will recognize that other elements are desirable and/or required in order to implement the present invention. However, because such elements are well known in the art, and because they do not facilitate a better understanding of the present invention, a discussion of such elements is not provided herein.

A computer on the internet space is globally accessible. Virtual private networking creates an encrypted tunnel into a particular private network or networks, such as a corporate or law firm network, for example, and the encrypted tunnel provides for any computer on the globally accessible space to be treated by the private network as a computer on the private, or internal, network.

In general, a computer on the globally accessible space cannot access the internal network because larger internal networks may limit access to the domain name service (DNS) of that internal network. This limitation on access to domain name service is traditionally provided using a split domain name service, meaning that the internal address space, which is unregistered and not routable to the global space outside of the private network fire wall, is assigned a different domain name server than that which is accessed to reach the publicly accessible address space. The internal domain name server may include, for example, addresses for mail exchangers, firm directory websites, and/or internal FTP sites.

A central difficulty in the use of a VPN connection is the operating system of the computer in use. For example, if the operating system, such as Windows, is programmed to attempt to access domain names through an improperly addressed domain name server, or through a domain name server for which the operating system does not have an address at all, the operating system will not have the ability to use the correct DNS servers in the right context. Consequently, the operating system will not be able to connect the computer to the desired DNS, and the user will not be able to access the desired information. However, using the virtual private networking (VPN) of the present invention, a DNS request is made by an authorized VPN program, such as a VPN client, and the computer is automatically attached to the internal corporate network via the VPN, regardless of what DNS servers the computer is programmed to use. In the case of an incorrect or unprogrammed DNS, the VPN rewrites the packet headers and redirects the packets to the DNS on which resides the desired internal information, regardless of the DNS the computer is programmed to use, and the VPN does so without any reprogramming of the operating system or software thereon. Thus, neither the user, nor the operating system, nor any pre-programmed software must have the correct DNS address for the internal space in order to reach the internal space, because all incoming and outgoing packets are rewritten by the VPN to reach the desired location, regardless of to what DNS the operating system or non-VPN software may have directed the packet.

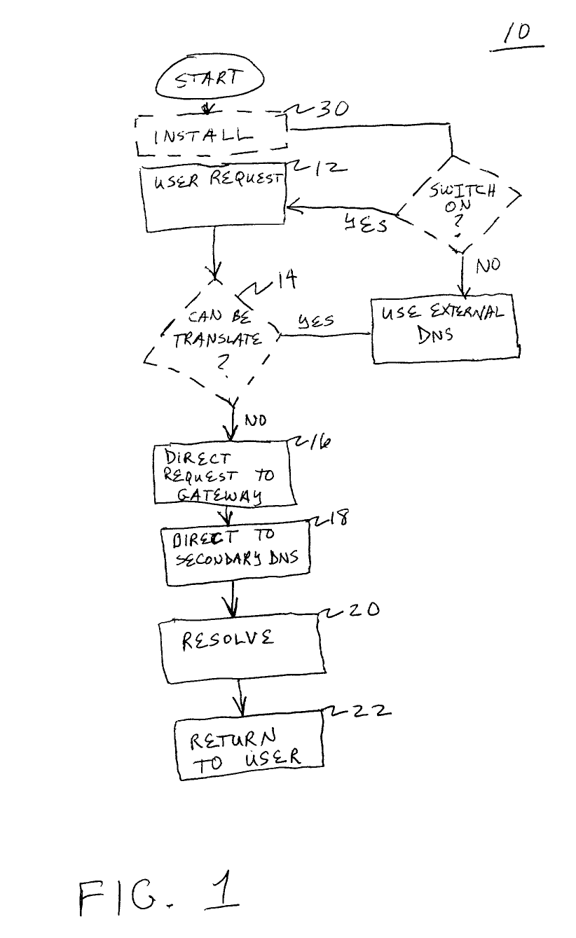

FIG. 1 is a flow diagram illustrating a method 10 of the virtual private networking. The method 10 includes step 12, wherein the user makes a request for information the address of which can be translated only by an internal, i.e. a private, DNS server, the optional step 14 wherein the VPN client detects that the address cannot be translated by the DNS server then-in-use by the client computer of the user, the step 16, wherein the VPN client redirects the request from the hard-coded DNS server then-in-use to the VPN gateway, the step 18, wherein the VPN gateway directs the request to a DNS server that can translate the requested address, such as an internal DNS server, the step 20, wherein the DNS server that can translate the requested address translates the requested address and returns the requested information to the VPN gateway, and step 22, wherein the requested information is returned to the user as if it had come directly from the internal DNS server, and preferably according to the protocol, i.e. having therein the IP address of, the hard-coded DNS server.

The present invention is applicable both inside the internal network and outside the internal network, such as in a dial-in environment to an ISP. In an external environment, the user may desire virtual private networking at home, through the use of a modem, a cable modem or a DSL, for example, to reach an ISP, or at a hotel or conference room where a familiar or unfamiliar dial-in or connection is performed for the user, at step 12. A familiar dial-in might be the user's preferred ISP, while an unfamiliar dial-in might be an ISP unknown to the user and, for example, chosen by the hotel. In an internal environment, there may be present a plurality of misconfigured computers, but the technical staff present may be inadequate to visit each desktop and properly re-configure each computer. In such an instance, installation of the VPN on all desktops would rewrite the office LAN and force all DNS queries to go to the correct location, according to the method of FIG. 1. The VPN application knows the correct address, and rewrites, or redirects, the packets to the correct location, at steps 16, 18, 20, and 22.

For example, where a user desires to reach an intranet server, the user might enter an address such as www.internalcompany.com, at step 12. In a typical embodiment, the computer would make a DNS query to resolve that to an IP address at step 12. However, if the user's computer and/or its operating system is not configured to point to the right, i.e. the internal, DNS server to resolve this address, i.e. where the necessary DNS server defines an internal server and split domain name service is used, the external internet DNS cannot do a symbolic name look-up whereby an IP address is ascertained from the entered internal address, because the external DNS does not recognize this symbolic address, and thus cannot associate an IP address with this symbolic address to allow the DNS to translate the symbolic name to the necessary IP address. Only where a user knows the IP address can such a site then be reached, and users rarely know IP addresses rather than symbolic names. Thus, if the computer does not have information adequate to point to the internal DNS, it cannot access information available at IP addresses only known to the internal DNS server.

As a more specific example, a DNS packet typically includes a header section including miscellaneous information about the query, and a question section, such as “address of www.abcd.com?”, and an answer section, such as “the address of www.abcd.com is 1.0.0.6, among other sections. If the question received cannot be answered by the DNS server to which the VPN client is connected, no information from the site www.abcd.com can be gained, because the DNS server cannot resolve the question, and thus cannot send the answer including the IP address. If the address cannot be resolved, the site cannot be connected to, and the desired information cannot be accessed by the user. This inability to resolve may be detected by the VPN client at step 14.

Consequently, a computer in the present invention includes the methodology to rewrite the packets to the correct IP address, regardless of whether the symbolic address can be associated with an IP address. This is accomplished through the use of the VPN system. The VPN is a mechanism external to the computer, operating system, and other computer applications, whereby an entered request for information resident only at addresses that can be translated by an internal DNS, or other private DNS server, is artificially resolved. The VPN redirects packets to the correct server, at steps 16 and 18, by translating the entered DNS name to the correct four octet IP address, irrespective of what DNS server the request was actually directed to. Thus, a VPN system operates on a semi-open principle, in that once a user has tunnelled into the VPN system, the computer can behave as though it is on the internal network.

Typically, a computer sets up the operating system with two or three or more IP addresses, i.e. four octet IP addresses, and instructs the operating system and applications that this location or these locations are where DNS lookup is to be done. For example, if a computer is set up to use an ISP, the ISP preprograms the ISP DNS servers as the servers to be used for communication by the operating system and applications, before power up or before dial up. Alternatively, where employees are given desktop access to the network, each employee computer is hard-coded to use the internal DNS server for private inquiries, and the extrenal DNS server for public inquiries.

In a preferred embodiment, the VPN client resident on the user's computer to grant the user access to the VPN system is a software program. The VPN client can be installed, for example, by download from a base server that is available for access to global users, or from an internal server, as at optional step 30, or on desktop computers at the home or at the office of authorized users, as at optional step 30, or on mobile computers of authorized users, as at optional step 30. The VPN client is preferably active or inactive, at the selection of the user or the installer. Upon activation, the VPN client may override, at step 16, the DNS assigned by, for example, an ISP into which the user's computer has dialed, in favor of the address of a VPN gateway. However, in the preferred embodiment, the VPN client does not overwrite the DNS addresses previously stored in applications or the operating system when inactive. Rather, the VPN client simply overrides those DNS addresses when active.

A VPN gateway is, in one embodiment, a server, may be computer or hardware specific, and provides an access tunnel to an internal server or network, such as an internal DNS server. The VPN gateway receives encrypted traffic from the VPN client, i.e. the computer of the user, at step 16, which encrypted traffic may be sent over the public ISP, and un-encrypts the traffic to form internet packets at step 18. The VPN gateway and the VPN client software provide a matched pair in that the VPN client for company A connects, in a preferred embodiment, only to the VPN gateway or gateways of company A. For example, a second VPN client of company B, programmed to connect to a different internal network for company B, cannot connect to the VPN gateway of company A, and thus cannot gain access to the internal network on company A. However, where a VPN client is compatible with multiple VPN gateways, the VPN client can be reconfigured to connect to a new VPN gateway. Additionally, where a VPN client is compatible with multiple VPN gateways, a single VPN client can be programmed to provide access to several VPN gateways. In a preferred embodiment, where several VPN gateways are available to a particular user, that user will be asked by the VPN client to select a gateway to which the VPN client will connect. Further, the VPN gateway may require additional information from the use for additional security before connecting to the internal network, such as a VPN gateway user password. Additionally, security is preferably provided at each VPN gateway to check that only authorized VPN clients are allowed to access that VPN gateway.

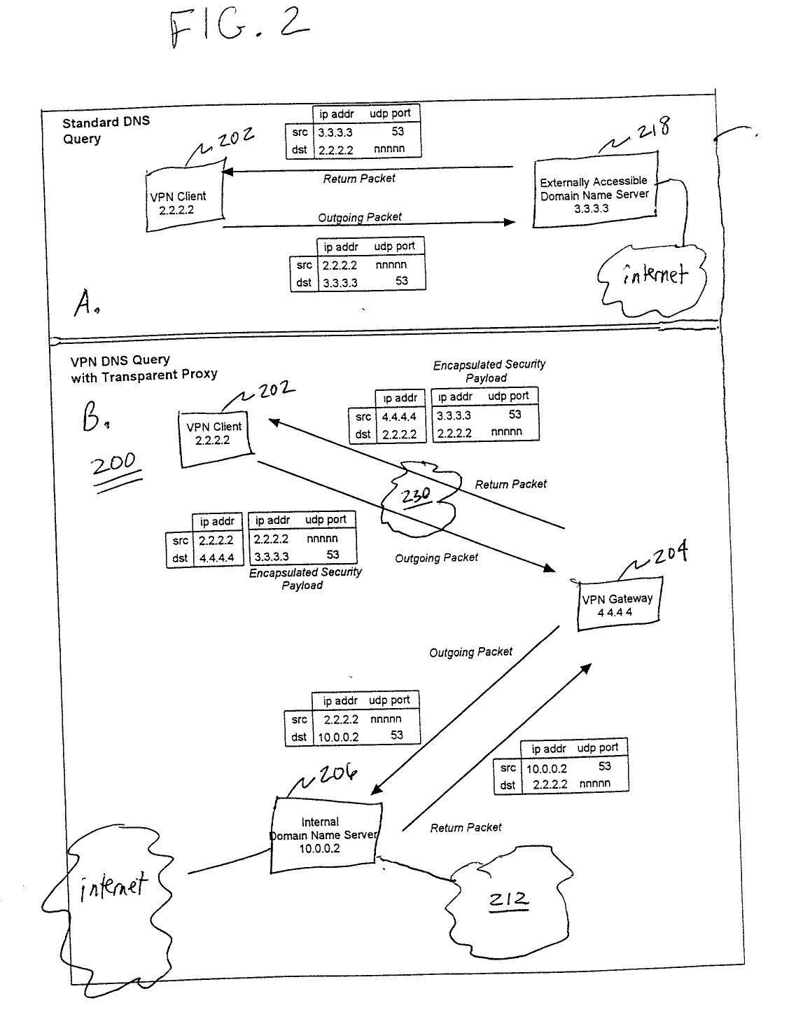

FIG. 2 is a block diagram illustrating a virtual private network 200, wherein the VPN client 202 is connected to the VPN gateway 204, and the connection of the VPN gateway 204 to the correct DNS server 206. Upon connection of the VPN client 202 to the VPN gateway 204 at step 16, the computer having the VPN client 202 thereon is no longer sending packetized information on an ISP 230, for example, unecrypted, rather, the packetized information is passed to and from the VPN gateway 204 in encrypted form. Thus, for security purposes, it is as if the VPN client 202 is directly on the internal network 212. In the exemplary embodiment of FIG. 2, a VPN client 202, which is at IP address 2.2.2.2, sends information packets to the VPN gateway 204 at IP address 4.4.4.4, which VPN gateway address is coded into the VPN client 202 at 2.2.2.2 as the address to which DNS inquiries unresolvable by the external DNS server 218 are to be sent. These packets are sent in an encrypted fashion. The VPN gateway 204 then changes the destination address on the packet so that the destination points to the internal domain name server 206 at 10.0.0.2, at step 18. The internal domain name server 206 then accesses, for example, that destination address on the intranet, or the internet, and returns the return packet to the VPN gateway 204 at step 20, which VPN gateway 204 returns the return packets, in encrypted fashion, to the VPN client 202, at step 22 of FIG. 1. The VPN client 202 and the VPN gateway 204 can communicate over a network outside the public internet, such as an intranet, or over the public internet, such as by ISP 230. Thus, the VPN gateway 204 is a proxy in that it serves as a replacement for the DNS server 218 the computer was originally directed to use. This replacement is invisible to the VPN client 202, and thus is invisible to the user, to whom it appears that the normal DNS server process is occurring, without any redirection. As such, the process is transparent to the user.

In a preferred embodiment, the internal server 206 or servers are able to resolve any internal or external address requested by the VPN client 202. Thus, for example, a request by a user to review the user's 401K plan on an internet financial site would be handled by the internal server 206, and would preferably be handled in the same manner as a request for a search of the company's private telephone directory.

In a preferred embodiment, the user needs no knowledge of the address of the VPN gateway 204. The VPN client 202 is preferably set up on the user's computer before any packets are sent to or from the user, such as at step 30, and before the user switches on the VPN client 202 at optional step 40, all to and from packets are sent through the preprogrammed, such as the ISP, DNS server 218. In general, those preprogrammed DNS servers 218 are hard coded onto the computer. The preprogrammed DNS servers 218 may be entered manually by the user, or may be software installed by, for example, an ISP installation application. Once the user switches on the VPN client 202 at step 40, the preprogrammed DNS servers 218 are capable of answering most queries, but, in a preferred embodiment, may not be used for even those inquiries that could be answered. Rather, all inquiries may be directed to the internal network server 206 via the VPN gateway 204.

When the VPN client 202 is switched on at step 40, the user may be, for example, connected to an ISP 230. The ISP 230 would preferably still be used for packet transport, but, by means of the encryption used by the VPN client 202, the user is tunneled into the VPN gateway 204 network for DNS inquiries, i.e. is drawn into an encapsulated security pin protocol. The packets encrypted by the VPN client 202 have therein a payload that includes the actual addresses that the user desires to reach. Thus, the VPN client 202 sends encrypted information over the ISP 230, which encrypted preferably cannot be un-encrypted by the ISP 230, to the VPN gateway 204. The VPN gateway 204 then decrypts the received information, and takes out the encrypted payload to create normal IP packets.

The VPN client 202 is preferably operable in multiple modes, shown at optional step 14. In the first mode, the VPN client 202 is inactive at step 40, and all inquiries are sent to the preprogrammed DNS 218, such as the ISP defined DNS. In the second mode, the VPN client 202 is active at step 40 and uses the preprogrammed DNS server 218 assigned, for example, by the ISP 230, for all inquiries that the preprogrammed DNS 218 can resolve, but, for inquiries that the preprogrammed DNS 218 cannot resolve, the VPN client 202 detects the inability to resolve at step 14 and uses the internal DNS server 206 via the VPN gateway 204. This use of the VPN gateway 204 can either be performed automatically by the VPN client 202 whenever the preprogrammed DNS server 218 is unable to resolve an address as detected at step 14, or may be user activated. In the third mode, the VPN client 202 would exclusively use the internal DNS server 206 via the VPN gateway 204, in that all queries would ultimately be sent via the gateway 204 to the internal DNS server 206, and returned via the same path, although it would appear to the VPN client that the query was sent to, and resolved by, the preprogrammed DNS 218. The use of multiple modes allows the alleviation of excess traffic on the VPN gateway 204 and the internal DNS server. Further, the use of multiple modes allows the user to use the internet for personal purposes without drawing on company resources, and without being exposed to monitoring mechanisms often employed by companies, and yet allows that user to use company resource for employment-related tasks.

FIG. 2 illustrates the three modes of operation for the transparent proxy mechanism. In part A of FIG. 2, a standard DNS query is performed, such as by the applications of an ISP provider. In part B of FIG. 2, a standard DNS query is performed but, where the DNS query fails, the VPN client 202 sends the query through the VPN gateway 204, rather than to the externally accessible DNS server 218. Alternatively in part B of FIG. 2, all inquiries may be sent to through the VPN gateway 204. As shown in the FIG. 2, to the end user all DNS inquiries appear to have originated at server 3.3.3.3, but inquiries not answered or answerable by server 3.3.3.3 are address-translated to the internal server at 10.0.0.2, and the return from server 10.0.0.2 is similarly translated to appear as if the response came from server 3.3.3.3. In other words, the information provided through the transparent DNS proxy server is the same, or substantially the same, information as that the user requested to see, although the actual DNS server may not be the one that appeared to the user to be used, according to the present invention.

Through the use of the method and system hereinabove, a user does not have to reenter main server addresses, or reboot his computer, when crashes of the user's computer occur. Even in the instance of a crash, as long as the VPN client retains the necessary information to locate the VPN gateway, i.e. the hard-coded VPN gateway IP address, a connection can be immediately re-established.

Those of ordinary skill in the art will recognize that many modifications and variations of the present invention may be implemented. The foregoing description and the following claims are intended to cover all such modifications and variations.

What is claimed is:

1. A method of virtual private networking, comprising:
receiving a request from at least one user for at least one address that can be translated by a second DNS server;
detecting that the at least one address cannot be translated by a first DNS server, wherein the first DNS server is then in use by the user;
redirecting the request from the first DNS server to a gateway, wherein the gateway directs the request to the second DNS server, and wherein the second DNS server resolves the request and returns the address to the gateway; and
receiving, from the gateway, the requested address formatted according to the first DNS server.

2. The method of claim 1, wherein the first DNS server is a dial-in server for an ISP.

3. The method of claim 1, wherein said receiving a user request comprises receiving a user request over at least one communication media selected from the group consisting of a modem, a cable modem, and a DSL.

4. The method of claim 1, wherein the first DNS server is a familiar server associated with a dial-in service.

5. The method of claim 1, wherein the first DNS server is an unfamiliar server associated with a dial-in service.

6. The method of claim 1, further comprising installing a client, wherein the client performs said receiving a request from a user, detecting, and receiving the requested address.

7. The method of claim 1, wherein the user request received is for an internal address.

8. The method of claim 7, wherein said detecting comprises:
attempting to obtain a resolution of the requested address by the first DNS server;
failing to receive a resolution from the first DNS server.

9. The method of claim 8, wherein the first DNS server is an external DNS server.

10. The method of claim 9, wherein said detecting further comprises activating a switch, wherein the switch, when inactive, points to the first DNS server, and, when active, points to the gateway.

11. The method of claim 1, wherein said redirecting comprises:
translating a first address of the first DNS server to a second address of the gateway, wherein the gateway redirects the request to the second DNS server.

12. The method of claim 11, wherein said translating comprises overriding the first address of the first DNS server.

13. The method of claim 12, wherein said redirecting further comprises encrypting communication to the gateway.

14. The method of claim 13, wherein the gateway unencrypts the communication prior to directing the communication to the second DNS server.

15. The method of claim 1, further comprising receiving at least one security check before said redirecting to the gateway.

16. A redirector that redirects a domain name service inquiry from a domain name server that cannot resolve the inquiry to a domain name service server that can resolve the inquiry, comprising:
a client;
at least one switch on said client;
a gateway communicatively connected to said client;
wherein said switch receives at least one domain name service inquiry directed to a first domain name server from said client; and
wherein, upon activation of said at least one switch, said switch redirects the at least one domain name service inquiry to at least one second domain name server through said gateway, which at least one second domain name server returns to said gateway a resolution of the at least one domain name service inquiry.

17. The redirector of claim 16, wherein, the redirect of the at least one domain name service inquiry through said gateway comprises an encrypted communication.

18. The redirector of claim 16, wherein said switch comprises an override.

19. The redirector of claim 18, wherein said override is activated by the user.

20. The redirector of claim 18, wherein said override is activated only when the first domain name server cannot resolve the at least one domain name service inquiry.

21. The redirector of claim 18, wherein said override overrides all domain name service inquiries upon activation.

22. The redirector of claim 16, further comprising a destination, wherein the resolution includes the destination, and wherein said at least one second domain name server returns to said gateway information from the destination.

23. The redirector of claim 16, wherein said gateway comprises an address overwriter that changes a destination address on the at least one domain name service inquiry from the first domain name server to the second domain name server.

24. The redirector of claim 23, wherein said gateway further returns the resolution to said client, and wherein said address overwriter overwrites a second address of the second domain name server with a first address of the first domain name server within the resolution for return to said client.

25. The redirector of claim 16, wherein the communicative connection comprises an ISP connection, and wherein the communicative connection comprises an encrypted connection.

26. The redirector of claim 16, wherein said client comprises a VPN client, and wherein said gateway comprises a VPN gateway, and wherein said switch comprises software code resident on said VPN client.

27. The redirector of claim 26, wherein said VPN client comprises software resident on at least one computer.

28. A virtual private network using domain name service proxy that redirects a domain name service inquiry from a first domain name server that cannot resolve the inquiry to a second domain name service server that can resolve the inquiry, comprising:
a user computer in communicative connection with a VPN client;
at least one switch within said VPN client;
a VPN gateway communicatively connected to said VPN client;
wherein said switch receives at least one domain name service inquiry directed to the first domain name server from said VPN client;
wherein, upon activation of said at least one switch, said switch redirects the at least one domain name service inquiry away from the first domain name server to the second domain name server through said gateway, by sending at least one encrypted payload including therein the at least one domain name service inquiry to said gateway, which gateway then unencrypts the payload and sends the payload to the second domain name server; and
wherein the second domain name server returns to said gateway a resolution of the at least one domain name service inquiry, wherein the resolution includes therein information from a destination address for the at least one domain name service inquiry; and
wherein said gateway encrypts the information and returns the information to said VPN client.

29. A virtual private network, comprising:
means for receiving a request from at least one user for at least one address that can be translated by a second DNS server;
means for detecting that the at least one address cannot be translated by a first DNS server, wherein the first DNS server is then in use by the user;
means for redirecting the request from the first DNS server to a gateway, wherein the gateway directs the request to the second DNS server, and wherein the second DNS server resolves the request and returns the address to the gateway; and
means for receiving, from the gateway, the requested address formatted according to the first DNS server.
